(19) United States
(12) Patent Application Publication
(10) Pub. No.: US 2024/0128613 A1
(43) Pub. Date: Apr. 18, 2024

(54) FLEXIBLE WIRING COMPONENT AND CONDUCTIVE MODULE

(71) Applicant: YAZAKI CORPORATION, Tokyo (JP)

(72) Inventors: Kimitoshi Makino, Makinohara-shi (JP); Shuhei Urakami, Makinohara-shi (JP)

(21) Appl. No.: 18/478,736

(22) Filed: Sep. 29, 2023

(30) Foreign Application Priority Data
Oct. 17, 2022 (JP) 2022-165959

(51) Int. Cl. H01M 50/569; H01M 50/209; H01M 50/298; H01M 50/507; H01M 50/519; H01M 50/55

(52) U.S. Cl. CPC H01M 50/569; H01M 50/209; H01M 50/298; H01M 50/507; H01M 50/519; H01M 50/55

(57) ABSTRACT

A first main branch wiring portion is bent at a first main branch bending portion and is extended in an array direction of a plurality of battery cells, a second main branch wiring portion is bent at a second main branch bending portion and is extended in the array direction, a coupling wiring portion includes a main coupling wiring portion, a first sub-coupling wiring portion, and a second sub-coupling wiring portion, the first sub-coupling wiring portion is bent at a first sub-branch bending portion and is extended to one end portion of the first main branch wiring portion, and the second sub-coupling wiring portion is bent at a second sub-branch bending portion and is extended to one end portion of the second main branch wiring portion.

### CROSS-REFERENCE TO RELATED APPLICATION(S)

The present application claims priority to and incorporates by reference the entire contents of Japanese Patent Application No. 2022-165959 filed in Japan on Oct. 17, 2022.

### BACKGROUND OF THE INVENTION

### 1. Field of the Invention

The present invention relates to a flexible wiring component and a conductive module.

### 2. Description of the Related Art

Conventionally, in a vehicle using a rotary machine as a driving source (such as an electric vehicle, a hybrid vehicle, or the like), a battery module that supplies power to the rotary machine and a battery monitoring unit that monitors a battery state of a plurality of battery cells included in the battery module are mounted. A flexible wiring component that electrically connects the battery module and the battery monitoring unit is mounted on the vehicle. Here, the battery module is formed by an array of a plurality of battery cells in which positive and negative electrode terminals are provided on the same plane, and includes a first electrode terminal group in which electrode terminals on one side are arranged in an array direction and a pair of the electrode terminals adjacent in the array direction is electrically connected by a first inter-terminal connection component for each pair of the electrode terminals, and a second electrode terminal group in which the electrode terminals on the other side are arranged in the array direction and a pair of the electrode terminals adjacent in the array direction is electrically connected by a second inter-terminal connection component for each pair of electrode terminals. Thus, the flexible wiring component includes a first main branch wiring portion that is electrically connected to each of the first inter-terminal connection components on a side of the first electrode terminal group between the first electrode terminal group and the second electrode terminal group, and a second main branch wiring portion that is electrically connected to each of the second inter-terminal connection components on a side of the second electrode terminal group between the first electrode terminal group and the second electrode terminal group. For example, Japanese Patent Application Laid-open No. 2022-74179 discloses the flexible wiring component.

Incidentally, as this type of flexible wiring component, what is configured as one component, that is, a component in which a first main branch wiring portion and a second main branch wiring portion are integrally molded via a coupling wiring portion has been known. For example, the flexible wiring component includes a voltage detection line for each first inter-terminal connection component which line is routed between the first main branch wiring portion and the coupling wiring portion between a first inter-terminal connection component side and a battery monitoring unit side, a voltage detection line for each second inter-terminal connection component which line is routed between the second main branch wiring portion and the coupling wiring portion between a second inter-terminal connection component side and the battery monitoring unit side, and insulating coating including all the voltage detection lines. As a specific example, the flexible wiring component includes a base film and a coverlay film for each surface which film covers a surface of the base film as the insulating coating, and a voltage detection line is routed on at least one surface of the base film.

For example, the flexible wiring component is one of a plurality of components die-cut from one sheet-like base material (in which a first film to be the base film, a voltage detection line for each flexible wiring component which line is routed on a surface of the first film, and a second film to be the coverlay film that covers each surface of the surfaces of the first film are stacked). The flexible wiring component described here has a space portion surrounded by the first main branch wiring portion, the second main branch wiring portion, and the coupling wiring portion, and an interval between the first main branch wiring portion and the second main branch wiring portion increases and the space portion becomes larger as an interval between the first electrode terminal group and the second electrode terminal group increases. Thus, in the flexible wiring component, there is a possibility that a portion corresponding to the space portion is wasted in the base material as the interval between the first electrode terminal group and the second electrode terminal group increases. As described above, the conventional flexible wiring component has room for improvement in terms of a yield.

### SUMMARY OF THE INVENTION

Thus, an object of the present invention is to provide a flexible wiring component and a conductive module having a good yield.

In order to achieve the above mentioned object, a flexible wiring component according to one aspect of the present invention includes a wiring main body in which a voltage detection line group that electrically connects a battery module, in which a plurality of battery cells is arrayed in a row, and a battery monitoring unit that monitors a battery state of each of the battery cells is included in insulating coating, the wiring main body being formed flat with flexibility, wherein in each of the battery cells, positive and negative electrode terminals are provided one by one at intervals on a same plane in a cell body, the battery module includes a first electrode terminal group in which the electrode terminals on one side in each of the battery cells are arranged in an array direction of the plurality of battery cells and a pair of the electrode terminals on the one side which electrode terminals are adjacent to each other in the array direction is electrically connected by a first inter-terminal connection component for each of the pairs of the electrode terminals on the one side, and a second electrode terminal group in which the electrode terminals on another side of each of the battery cells are arranged in the array direction and a pair of the electrode terminals on the other side which electrode terminals are adjacent to each other in the array direction is electrically connected by a second inter-terminal connection component for each of the pairs of the other electrode terminals, the voltage detection line group includes a first voltage detection line that is provided for each of the first inter-terminal connection components and that electrically connects the first inter-terminal connection component and the battery monitoring unit, and a second voltage detection line that is provided for each of the second inter-terminal connection components and that electrically connects the second inter-terminal connection component and the battery monitoring unit, the wiring main body includes a first main branch wiring portion that extends in the array direction on a side of the first electrode terminal group between the first electrode terminal group and the second electrode terminal group, a second main branch wiring portion that extends in the array direction on a side of the second electrode terminal group between the first electrode terminal group and the second electrode terminal group, and a coupling wiring portion that has one end portion continuous with one end portion of the first main branch wiring portion and another end portion continuous with one end portion of the second main branch wiring portion, that couples the one end portions of the first main branch wiring portion and the second main branch wiring portion, and that makes electric connection to the battery monitoring unit, the first main branch wiring portion is bent at a first main branch bending portion at a boundary between the one end portion thereof and the one end portion of the coupling wiring portion and is extended in the array direction, the second main branch wiring portion is bent at a second main branch bending portion at a boundary between the one end portion thereof and the other end portion of the coupling wiring portion and is extended in the array direction, the coupling wiring portion includes a main coupling wiring portion electrically connected to the battery monitoring unit, a first sub-coupling wiring portion that branches off from the main coupling wiring portion, that is coupled to the one end portion of the first main branch wiring portion via the first main branch bending portion, and that electrically connects the main coupling wiring portion and the first main branch wiring portion, and a second sub-coupling wiring portion that branches off from the main coupling wiring portion, that is coupled to the one end portion of the second main branch wiring portion via the second main branch bending portion, and that electrically connects the main coupling wiring portion and the second main branch wiring portion, the first sub-coupling wiring portion is bent at a first sub-branch bending portion branching off from the main coupling wiring portion and is extended to the one end portion of the first main branch wiring portion, and the second sub-coupling wiring portion is bent at a second sub-branch bending portion branching off from the main coupling wiring portion and is extended to the one end portion of the second main branch wiring portion.

In order to achieve the above mentioned object, a conductive module according to another aspect of the present invention includes a flexible wiring component; a first inter-terminal connection component; a second inter-terminal connection component; and a case that houses the flexible wiring component, the first inter-terminal connection component, and the second inter-terminal connection component from an opening, wherein the flexible wiring component includes a wiring main body in which a voltage detection line group that electrically connects a battery module, in which a plurality of battery cells is arrayed in a row, and a battery monitoring unit that monitors a battery state of each of the battery cells is included in insulating coating, the wiring main body being formed flat with flexibility, in each of the battery cells, positive and negative electrode terminals are provided one by one at intervals on a same plane in a cell body, the battery module includes a first electrode terminal group in which the electrode terminals on one side of each of the battery cells are arranged in an array direction of the plurality of battery cells and a pair of the electrode terminals on the one side which electrode terminals are adjacent to each other in the array direction is electrically connected by the first inter-terminal connection component for each pair of the electrode terminals on the one side, and a second electrode terminal group in which the electrode terminals on another side of each of the battery cells are arranged in the array direction and a pair of the electrode terminals on the other side which electrode terminals are adjacent to each other in the array direction is electrically connected by the second inter-terminal connection component for each pair of the electrode terminals on the other side, the voltage detection line group includes a first voltage detection line that is provided for each of the first inter-terminal connection components and that electrically connects the first inter-terminal connection component and the battery monitoring unit, and a second voltage detection line that is provided for each of the second inter-terminal connection components and that electrically connects the second inter-terminal connection component and the battery monitoring unit, the wiring main body includes a first main branch wiring portion that is extended in the array direction on a side of the first electrode terminal group between the first electrode terminal group and the second electrode terminal group, a second main branch wiring portion that is extended in the array direction on a side of the second electrode terminal group between the first electrode terminal group and the second electrode terminal group, and a coupling wiring portion that has one end portion continuous with one end portion of the first main branch wiring portion and another end portion continuous with one end portion of the second main branch wiring portion, that couples the one end portions of the first main branch wiring portion and the second main branch wiring portion, and makes electrical connection to the battery monitoring unit, the first main branch wiring portion is bent at a first main branch bending portion at a boundary between the one end portion thereof and the one end portion of the coupling wiring portion and is extended in the array direction, the second main branch wiring portion is bent at a second main branch bending portion at a boundary between the one end portion thereof and the other end portion of the coupling wiring portion and is extended in the array direction, the coupling wiring portion includes a main coupling wiring portion electrically connected to the battery monitoring unit, a first sub-coupling wiring portion that branches off from the main coupling wiring portion, that is coupled to the one end portion of the first main branch wiring portion via the first main branch bending portion, and that electrically connects the main coupling wiring portion and the first main branch wiring portion, and a second sub-coupling wiring portion that branches off from the main coupling wiring portion, that is coupled to the one end portion of the second main branch wiring portion via the second main branch bending portion, and that electrically connects the main coupling wiring portion and the second main branch wiring portion, the first sub-coupling wiring portion is bent at a first sub-branch bending portion branching off from the main coupling wiring portion and is extended to the one end portion of the first main branch wiring portion, the second sub-coupling wiring portion is bent at a second sub-branch bending portion branching off from the main coupling wiring portion and is extended to the one end portion of the second main branch wiring portion, and the case includes a first housing chamber that houses the first main branch wiring portion from a first opening, a second housing chamber that houses the second main branch wiring portion from a second opening, a third housing chamber that houses the first inter-terminal connection component from a third opening, a fourth housing chamber that houses the second inter-terminal connection component from a fourth opening, a first cover portion that closes the first opening, a second cover portion that closes the second opening, a third cover portion that closes the third opening, a fourth cover portion that closes the fourth opening, a first hinge portion that rotates the third cover portion between an open position and a closed position with respect to the third opening, and a second hinge portion that rotates the fourth cover portion between an open position and a closed position with respect to the fourth opening.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating a flexible wiring component of an embodiment installed in a battery module;

FIG. 2 is a view illustrating the flexible wiring component of the embodiment;

FIG. 3 is a view for describing a stacked structure of the flexible wiring component;

FIG. 4 is a view illustrating a state of a semi-finished product of the flexible wiring component of the embodiment;

FIG. 5 is a view illustrating a modification of the flexible wiring component of the embodiment;

FIG. 6 is a view illustrating a modification of the flexible wiring component of the embodiment;

FIG. 7 is a view illustrating a case in which the flexible wiring component of the embodiment is housed;

FIG. 8 is a view illustrating a modification of the case in which the flexible wiring component of the embodiment is housed;

FIG. 9 is a view illustrating a modification of the flexible wiring component of the embodiment;

FIG. 10 is a view illustrating a modification of the flexible wiring component of the embodiment;

FIG. 11 is a view illustrating a modification of the flexible wiring component of the embodiment installed in the battery module, and illustrating the component after bending of an increase circuit wiring portion;

FIG. 12 is a view illustrating a modification of the flexible wiring component of the embodiment installed in the battery module, and illustrating the component before bending of the increase circuit wiring portion;

FIG. 13 is a view illustrating a state of a semi-finished product of the flexible wiring component of the modification;

FIG. 14 is a view for describing a stacked structure of a bent portion;

FIG. 15 is a view for describing the stacked structure of the bent portion;

FIG. 16 is a view illustrating another form of the flexible wiring component of the modification;

FIG. 17 is a view for describing a shielding plate; and

FIG. 18 is a view for describing the shielding plate.

### DETAILED DESCRIPTION OF THE PREFERRED EMBODIMENTS

Hereinafter, embodiments of a flexible wiring component and a conductive module according to the present invention will be described in detail with reference to the drawings. Note that this invention is not limited to this embodiment.

### Embodiment

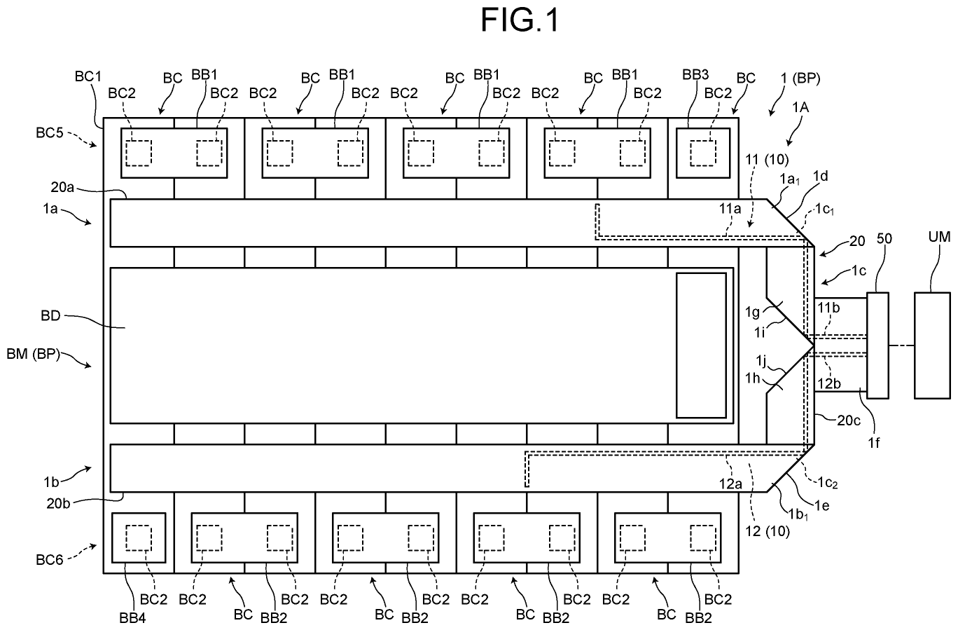

One of embodiments of the flexible wiring component and the conductive module according to the present invention will be described with reference to FIG. 1 to FIG. 15.

A reference sign 1 in FIG. 1 to FIG. 15 denotes the flexible wiring component of the present embodiment. A flexible wiring component 1 is assembled to a battery module BM in which a plurality of battery cells BC is arrayed in a row, and constitute a battery pack BP together with the battery module BM (FIG. 1). The battery pack BP is mounted on, for example, a vehicle (such as an electric vehicle or a hybrid vehicle) including a rotary machine as a driving source, and is used to supply power to the rotary machine.

Each of the battery cells BC includes a cell body BC1 and positive and negative electrode terminals BC2, and the two electrode terminals BC2 are provided one by one at intervals on the same plane in the cell body BC1 (FIG. 1).

In the battery cell BC described here, the cell body BC1 is formed in a rectangular parallelepiped shape having six outer wall surfaces, and the two electrode terminals BC2 are provided on one of the six outer wall surfaces of the cell body BC1. In the plurality of battery cells BC included in the battery module BM, the cell bodies BC1 adjacent to each other in an array direction are arranged in such a manner that one outer wall surfaces thereof face each other. Thus, in the battery cell BC described here, among the six outer wall surfaces of the cell body BC1, the two electrode terminals BC2 are provided on one of the four outer wall surfaces in the array direction of the plurality of battery cells BC. On the one outer wall surface of the cell body BC1, the electrode terminal BC2 serving as a positive electrode is arranged at one end in a direction orthogonal to the array direction of the plurality of battery cells BC, and the electrode terminal BC2 serving as a negative electrode is arranged at the other end in the orthogonal direction.

Each of the electrode terminals BC2 may have, for example, a plate shape or a rectangular parallelepiped shape provided on one outer wall surface of the cell body BC1, and may be a columnar electrode pole protruding from the one outer wall surface of the cell body BC1. In a case of the plate-like or rectangular parallelepiped electrode terminal BC2, a first inter-terminal connection component BB1, a second inter-terminal connection component BB2, a total positive electrode connection component BB3, or a total negative electrode connection component BB4 (described later) is physically and electrically connected to the electrode terminal BC2 by welding or the like. Furthermore, in a case of the electrode terminal BC2 as the electrode pole, since a male screw portion is provided in the electrode terminal BC2, the electrode terminal BC2 is inserted into a through hole of the first inter-terminal connection component BB1, the second inter-terminal connection component BB2, the total positive electrode connection component BB3, or the total negative electrode connection component BB4 (described later), and a female screw member is screwed into the male screw portion of the electrode terminal BC2, whereby the first inter-terminal connection component BB1, the second inter-terminal connection component BB2, the total positive electrode connection component BB3, or the total negative electrode connection component BB4 is physically and electrically connected to the electrode terminal BC2. Here, the rectangular plate-like electrode terminal BC2 is taken as an example.

The battery module BM includes a first electrode terminal group BC5 in which electrode terminals BC2 on one side in each of the battery cells BC are arranged in the array direction of the plurality of battery cells BC and a pair of the electrode terminals BC2 on the one side which electrode terminals are adjacent to each other in the array direction is electrically connected by the first inter-terminal connection component BB1 for each pair of the electrode terminals BC2 on the one side, and a second electrode terminal group BC6 in which the electrode terminals BC2 on the other side in each of the battery cells BC are arranged in the array direction of the plurality of battery cells BC and a pair of the electrode terminals BC2 on the other side which electrode terminals are adjacent to each other in the array direction is electrically connected by the second inter-terminal connection component BB2 for each pair of the electrode terminals BC2 on the other side (FIG. 1).

In the battery module BM, in a case where the plurality of battery cells BC is electrically connected in series, the plurality of battery cells BC is arranged in such a manner that the electrode terminals BC2 on the one side in the first electrode terminal group BC5 become the positive electrodes and the negative electrodes alternately arranged in the array direction, and the electrode terminals BC2 on the other side in the second electrode terminal group BC6 become the negative electrodes and the positive electrodes alternately arranged in the array direction. On the other hand, in the battery module BM, in a case where the plurality of battery cells BC is electrically connected in parallel, the plurality of battery cells BC is arranged in such a manner that all the electrode terminals BC2 on the one side in the first electrode terminal group BC5 become the positive electrodes and all the electrode terminals BC2 on the other side in the second electrode terminal group BC6 become the negative electrodes.

The first electrode terminal group BC5 includes a plurality of pairs of the electrode terminals BC2 on the one side, and one electrode terminal BC2 on the one side which electrode terminal is not included in the combination the pairs. The second electrode terminal group BC6 includes a plurality of pairs of the electrode terminals BC2 on the other side, and one electrode terminal BC2 on the other side which electrode terminal is not included in the combination the pairs. In the battery module BM, one of the two electrode terminals BC2 not included in the combination becomes a total positive electrode, and the other becomes a total negative electrode. In the battery module BM, the total positive electrode connection component BB3 is electrically connected to the electrode terminal BC2 that functions as the total positive electrode, and the total negative electrode connection component BB4 is electrically connected to the electrode terminal BC2 that functions as the total negative electrode (FIG. 1).

Each of the first inter-terminal connection component BB1, the second inter-terminal connection component BB2, the total positive electrode connection component BB3, and the total negative electrode connection component BB4 is a plate-like conductive component made of metal, and is referred to as a bus bar. Although the first inter-terminal connection component BB1 and the second inter-terminal connection component BB2 described here are the same conductive component, names thereof are distinguished for convenience of description. In addition, although the total positive electrode connection component BB3 and the total negative electrode connection component BB4 described here are the same conductive component, names thereof are distinguished for convenience of description.

The battery module BM described here includes an exhaust duct BD, which exhausts gas exhausted from the inside of the battery cell BC to the outside, between the first electrode terminal group BC5 and the second electrode terminal group BC6 (FIG. 1). Here, the exhaust duct BD is provided at a center between the first electrode terminal group BC5 and the second electrode terminal group BC6.

A battery monitoring unit UM that monitors a battery state of each of the battery cells BC in the battery module BM is mounted on the vehicle (FIG. 1). The battery module BM and the battery monitoring unit UM are electrically connected by the flexible wiring component 1.

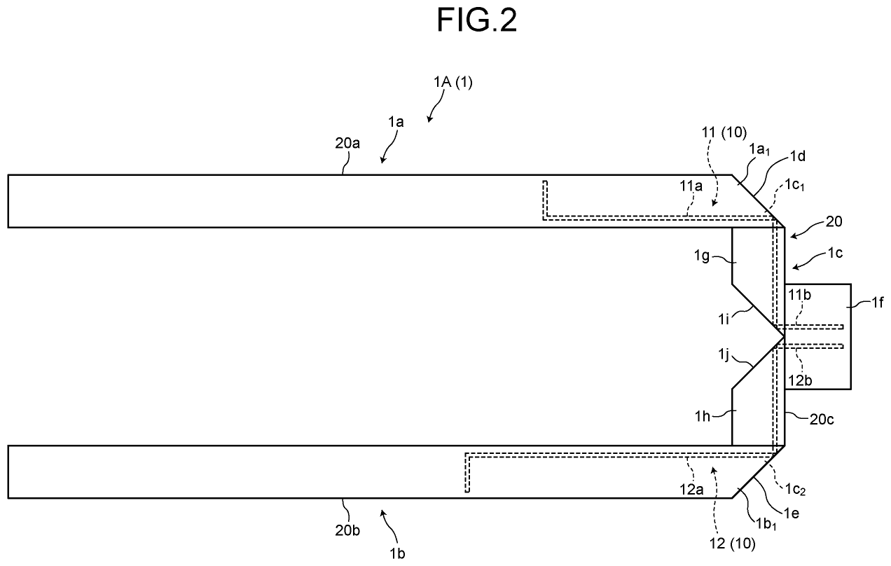

The flexible wiring component 1 includes a wiring main body 1A in which a voltage detection line group 10 that electrically connects the battery module BM and the battery monitoring unit UM is included in insulating coating 20 and which is formed flat with flexibility (FIG. 1 and FIG. 2).

The voltage detection line group 10 includes a plurality of the voltage detection lines having flexibility. The voltage detection line group 10 includes a first voltage detection line 11 that is provided for each first inter-terminal connection component BB1 and that electrically connects the first inter-terminal connection component BB1 and the battery monitoring unit UM, and a second voltage detection line 12 that is provided for each second inter-terminal connection component BB2 and that electrically connects the second inter-terminal connection component BB2 and the battery monitoring unit UM (FIG. 1 and FIG. 2). Furthermore, the voltage detection line group 10 described here includes the first voltage detection line 11 that electrically connects the total positive electrode connection component BB3 and the battery monitoring unit UM, and a second voltage detection line 12 that electrically connects the total negative electrode connection component BB4 and the battery monitoring unit UM. Note that only a part of a plurality of the first voltage detection lines 11 and a part of a plurality of the second voltage detection lines 12 are illustrated in the drawing.

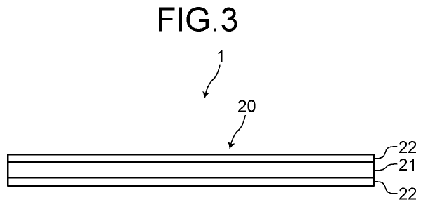

The flexible wiring component 1 described here is a flexible printed circuit board (so-called FPC), and each of the voltage detection lines (first voltage detection line 11 and second voltage detection line 12) of the voltage detection line group 10 is formed by a conductor pattern, and the insulating coating 20 is formed of various films which is formed flat with flexibility. The insulating coating 20 includes a base film 21 and a coverlay film 22 for each surface which film covers the surface of the base film 21 (FIG. 3). Each of the voltage detection lines is formed on at least one surface of the base film 21 as a circuit pattern of a conductor pattern, whereby the voltage detection line group 10 is routed on the surface. For example, in a case where each of the voltage detection lines of the voltage detection line group 10 is formed only on the one surface of the base film 21, the flexible wiring component 1 is configured as a single-sided flexible printed circuit board having one conductor pattern layer. In addition, in a case where each of the voltage detection lines of the voltage detection line group 10 is formed on both surfaces of the base film 21, the flexible wiring component 1 is configured as a double-sided flexible printed circuit board having two conductor pattern layers.

Specifically, the wiring main body 1A includes a first main branch wiring portion 1a that extends in the array direction of the plurality of battery cells BC on a side of the first electrode terminal group BC5 between the first electrode terminal group BC5 and the second electrode terminal group BC6, and a second main branch wiring portion 1b that extends in the array direction of the plurality of battery cells BC on a side of the second electrode terminal group BC6 between the first electrode terminal group BC5 and the second electrode terminal group BC6 (FIG. 1 and FIG. 2).

The first main branch wiring portion 1a includes a first main branch coating portion 20a of the insulating coating 20 and first main branch conductive portions 11a of all the first voltage detection lines 11 (FIG. 1 and FIG. 2). The first main branch coating portion 20a is a portion extending in the array direction of the plurality of battery cells BC on a side of the first electrode terminal group BC5 between the first electrode terminal group BC5 and the second electrode terminal group BC6 in the insulating coating 20, and is formed of a corresponding portion of the base film 21 and the coverlay film 22. Each of the first main branch conductive portions 11a is a portion that extends in the array direction of the plurality of battery cells BC between the first electrode terminal group BC5 and the second electrode terminal group BC6 in the first voltage detection line 11 and that is included in the first main branch coating portion 20a, and is formed at a corresponding portion of the surface of the base film 21 in the first main branch coating portion 20a.

For example, the flexible wiring component 1 includes an electrical connection component (not illustrated) such as an electric wire for each first inter-terminal connection component BB1 which electrical connection component electrically connects the first main branch conductive portion 11a to the first inter-terminal connection component BB1. Furthermore, the flexible wiring component 1 includes an electrical connection component (not illustrated) such as an electric wire that electrically connects the first main branch conductive portion 11a for the total positive electrode connection component BB3 to the total positive electrode connection component BB3.

The second main branch wiring portion 1b includes a second main branch coating portion 20b of the insulating coating 20 and second main branch conductive portions 12a of all the second voltage detection lines 12 (FIG. 1 and FIG. 2). The second main branch coating portion 20b is a portion extending in the array direction of the plurality of battery cells BC on a side of the second electrode terminal group BC6 between the first electrode terminal group BC5 and the second electrode terminal group BC6 in the insulating coating 20, and is formed of a corresponding portion of the base film 21 and the coverlay film 22. Each of the second main branch conductive portions 12a is a portion that extends in the array direction of the plurality of battery cells BC between the first electrode terminal group BC5 and the second electrode terminal group BC6 in the second voltage detection line 12 and that is included in the second main branch coating portion 20b, and is formed at a corresponding portion of the surface of the base film 21 in the second main branch coating portion 20b.

For example, the flexible wiring component 1 includes an electrical connection component (not illustrated) such as an electric wire for each second inter-terminal connection component BB2 which electrical connection component electrically connects the second main branch conductive portion 12a to the second inter-terminal connection component BB2. Furthermore, the flexible wiring component 1 includes an electrical connection component (not illustrated) such as an electric wire which electrical connection component electrically connects the second main branch conductive portion 12a for the total negative electrode connection component BB4 to the total negative electrode connection component BB4.

Furthermore, the wiring main body 1A includes a coupling wiring portion 1c that couples one end portions 1a₁ and 1b₁ of the first main branch wiring portion 1a and the second main branch wiring portion 1b, and makes electric connection to the battery monitoring unit UM (FIG. 1 and FIG. 2). The coupling wiring portion 1c has one end portion 1c₁ continuous with the one end portion 1a₁ of the first main branch wiring portion 1a and the other end portion 1c₂ continuous with the one end portion 1b₁ of the second main branch wiring portion 1b. A connector 50 to be fitted and connected to a connector (not illustrated) on a side of the battery monitoring unit UM is provided in the coupling wiring portion 1c (FIG. 1).

The coupling wiring portion 1c includes a coupling coating portion 20c of the insulating coating 20, first unit-side connection portions 11b of all the first voltage detection lines 11, and second unit-side connection portions 12b of all the second voltage detection lines 12 (FIG. 1 and FIG. 2). The coupling coating portion 20c is a portion in which the one end portions of the first main branch coating portion 20a and the second main branch coating portion 20b are coupled to each other in the insulating coating 20, and is formed of a corresponding portion of the base film 21 and the coverlay film 22. Furthermore, the first unit-side connection portion 11b is a portion that is bent from one end of the first main branch conductive portion 11a to a side of the coupling coating portion 20c, is included in the coupling coating portion 20c therebeyond, and is electrically connected to the battery monitoring unit UM at a tip end thereof, and is formed at a corresponding portion of the surface of the base film 21 in the coupling coating portion 20c. The second unit-side connection portion 12b is a portion that is bent from one end of the second main branch conductive portion 12a to a side of the coupling coating portion 20c, is included in the coupling coating portion 20c therebeyond, and is electrically connected to the battery monitoring unit UM at a tip end thereof, and is formed at a corresponding portion of the surface of the base film 21 in the coupling coating portion 20c.

Here, in the wiring main body LA, the first main branch wiring portion 1a is formed by being bent from the side of the coupling wiring portion 1c, and the second main branch wiring portion 1b is formed by being bent from the side of the coupling wiring portion 1c. The first main branch wiring portion 1a is bent at a first main branch bending portion 1d at a boundary between the one end portion 1a₁ thereof and the one end portion 1c₁ of the coupling wiring portion 1c, and is extended in the array direction of the plurality of battery cells BC (FIG. 1 and FIG. 2). The second main branch wiring portion 1b is bent at a second main branch bending portion 1e at a boundary between the one end portion 1b₁ thereof and the other end portion 1c₂ of the coupling wiring portion 1c, and is extended in the array direction of the plurality of battery cells BC (FIG. 1 and FIG. 2).

Furthermore, the coupling wiring portion 1c of the wiring main body 1A includes a main coupling wiring portion 1f electrically connected to the battery monitoring unit UM, a first sub-coupling wiring portion 1g that branches off from the main coupling wiring portion 1f, that is coupled to the one end portion 1a₁ of the first main branch wiring portion 1a via the first main branch bending portion 1d, and that electrically connects the main coupling wiring portion 1f and the first main branch wiring portion 1a, and a second sub-coupling wiring portion 1h that branches off from the main coupling wiring portion 1f, that is coupled to the one end portion 1b₁ of the second main branch wiring portion 1b via the second main branch bending portion 1e, and that electrically connects the main coupling wiring portion 1f and the second main branch wiring portion 1b (FIG. 1 and FIG. 2). The first sub-coupling wiring portion 1g is bent at a first sub-branch bending portion 1i that branches off from the main coupling wiring portion 1f, is extended to the one end portion 1a₁ of the first main branch wiring portion 1a, and is coupled to the one end portion 1a₁ via the first main branch bending portion 1d (FIG. 1 and FIG. 2). The second sub-coupling wiring portion 1h is bent at a second sub-branch bending portion 1j that branches off from the main coupling wiring portion 1f, is extended to the one end portion 1b₁ of the second main branch wiring portion 1b, and is coupled to the one end portion 1b₁ via the second main branch bending portion 1e (FIG. 1 and FIG. 2).

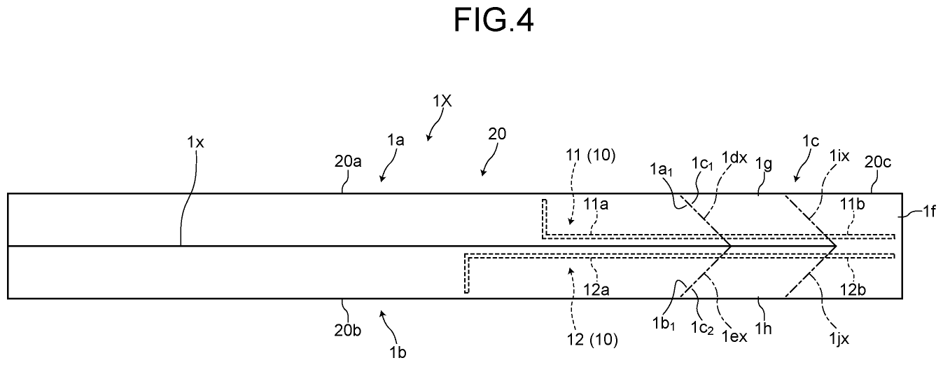

The wiring main body LA is one of a plurality of rectangular components die-cut from one sheet-like base material (in which a first film to be the base film 21, the first voltage detection line 11 and the second voltage detection line 12 for each flexible wiring component 1 which lines are routed on the surface of the first film, and a second film to be the coverlay film 22 that covers each surface of the surfaces of the first film), and is formed by bending processing of the rectangular semi-finished product 1X (FIG. 4).

The semi-finished product 1X has a slit 1x that performs division into a side of the first main branch wiring portion 1a and a side of the first sub-coupling wiring portion 1g, a side of the second main branch wiring portion 1b and a side of the second sub-coupling wiring portion 1h, and a side of the main coupling wiring portion 1f (FIG. 4). The slit 1x may be formed when the semi-finished product 1X is die-cut from the base material, or may be formed by a cut after the semi-finished product 1X is die-cut from the base material. Furthermore, the slit 1x may be formed by partial connection of the side of the first main branch wiring portion 1a and the side of the first sub-coupling wiring portion 1g, and the side of the second main branch wiring portion 1b and the side of the second sub-coupling wiring portion 1h when the semi-finished product 1X is die-cut from the base material, and a coupling portion thereof may be cut after the die-cutting from the base material.

In the wiring main body 1A, in the semi-finished product 1X, the first main branch wiring portion 1a and the first sub-coupling wiring portion 1g protruding linearly from the main coupling wiring portion 1f are bent by 90 degrees at the first sub-branch bending portion 1i in such a manner as to be orthogonal to a protruding direction thereof, and the second main branch wiring portion 1b and the second sub-coupling wiring portion 1h protruding linearly from the main coupling wiring portion 1f are bent by 90 degrees at the second sub-branch bending portion 1j in such a manner as to be orthogonal to a protruding direction thereof. In the wiring main body 1A, the first main branch wiring portion 1a and the first sub-coupling wiring portion 1g, and the second main branch wiring portion 1b and the second sub-coupling wiring portion 1h are bent in such a manner as to face opposite sides.

Furthermore, in the wiring main body 1A, in the semi-finished product 1X, the first main branch wiring portion 1a and the first sub-coupling wiring portion 1g are bent by 90 degrees at the first main branch bending portion 1d in such a manner as to be orthogonal to each other, and the second main branch wiring portion 1b and the second sub-coupling wiring portion 1h are bent by 90 degrees at the second main branch bending portion 1e in such a manner as to be orthogonal to each other. In the wiring main body 1A, the first main branch wiring portion 1a and the second main branch wiring portion 1b are bent in such a manner as to face the same direction respectively with respect to the first sub-coupling wiring portion 1g and the second sub-coupling wiring portion 1h.

That is, in the wiring main body 1A, the first sub-coupling wiring portion 1g protruding from the main coupling wiring portion 1f is bent by 90 degrees in the protruding direction thereof at the first sub-branch bending portion 1i, the first main branch wiring portion 1a is bent by 90 degrees at the first main branch bending portion 1d with respect to the first sub-coupling wiring portion 1g, the second sub-coupling wiring portion 1h protruding from the main coupling wiring portion 1f is bent by 90 degrees in the protruding direction thereof in a direction opposite to the first sub-coupling wiring portion 1g at the second sub-branch bending portion 1j, and the second main branch wiring portion 1b is bent by 90 degrees at the second main branch bending portion 1e with respect to the second sub-coupling wiring portion 1h in the same direction as the first main branch wiring portion 1a.

In the semi-finished product 1x, the wiring main body 1A is formed by being bent at folds 1dx, 1ex, 1ix, and 1jx that are to form the first main branch bending portion 1d, the second main branch bending portion 1e, the first sub-branch bending portion 1i, and the second sub-branch bending portion 1j respectively (FIG. 4-4 FIG. 2). The folds 1dx, 1ex, 1ix, and 1jx may be provided on the semi-finished product 1X in such a manner as to be visually recognizable marks, or may not be provided on the semi-finished product 1X as marks.

In such a manner, in the wiring main body 1A, a portion between the first main branch wiring portion 1a and the first sub-coupling wiring portion 1g is bent at the first main branch bending portion 1d, a portion between the second main branch wiring portion 1b and the second sub-coupling wiring portion 1h is bent at the second main branch bending portion 1e, a portion between the main coupling wiring portion 1f and the first sub-coupling wiring portion 1g is bent at the first sub-branch bending portion 1i, and a portion between the main coupling wiring portion 1f and the second sub-coupling wiring portion 1h is bent at the second sub-branch bending portion 1j. Thus, in the wiring main body 1A, regardless of a size of the interval between the first electrode terminal group BC5 and the second electrode terminal group BC6, the semi-finished product 1X that does not leave the space portion surrounded by the first main branch wiring portion 1a, the second main branch wiring portion 1b, and the coupling wiring portion 1c in the base material can be cut out from the base material. Thus, in the flexible wiring component 1 of the present embodiment, it is possible to improve a yield of when a plurality of the wiring main bodies 1A is die-cut from the base material regardless of the size of the interval between the first electrode terminal group BC5 and the second electrode terminal group BC6.

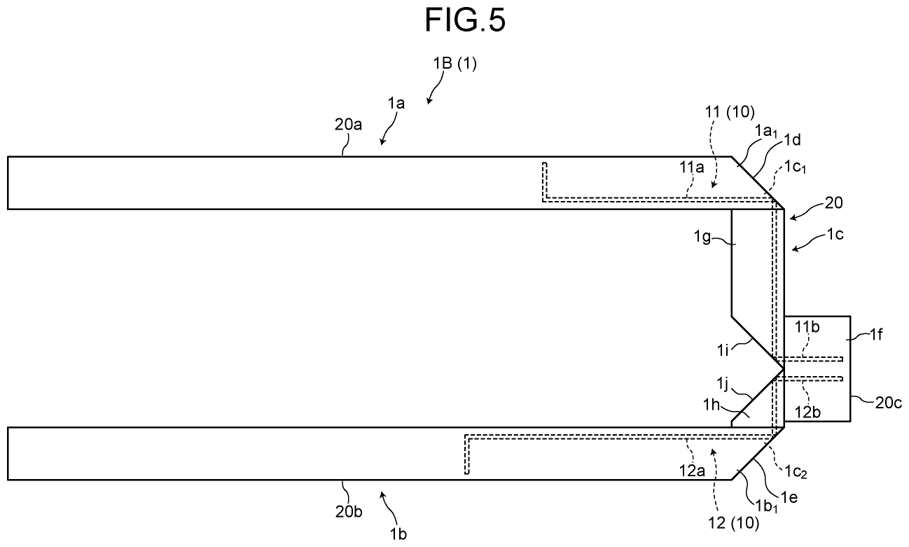

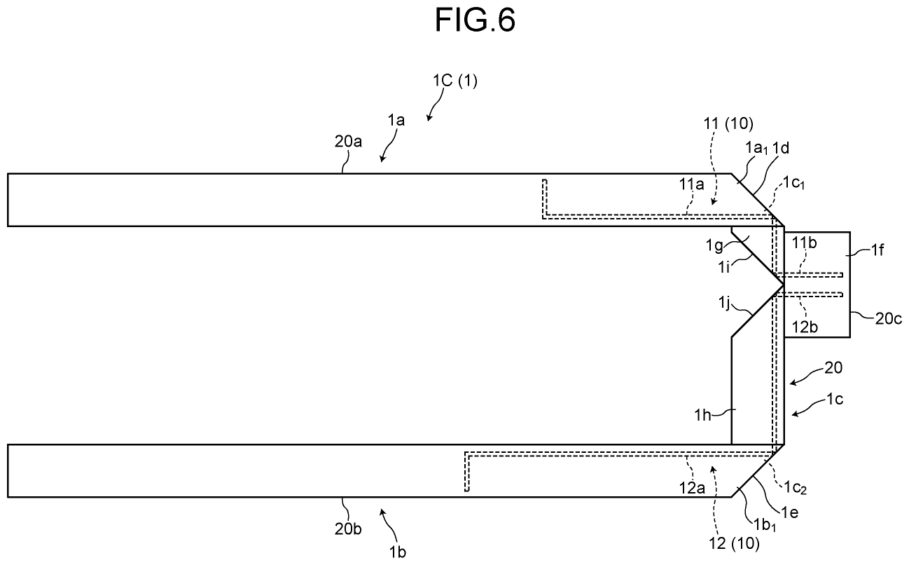

Incidentally, in the flexible wiring component 1 of the present embodiment, the wiring main body 1A may be replaced with a wiring main body 1B or 1C in the following (FIG. 5 and FIG. 6).

The wiring main body 1B is formed of a semi-finished product (not illustrated) in which a side of the first main branch wiring portion 1a and a side of the first sub-coupling wiring portion 1g are extended compared to a side of the second main branch wiring portion 1b and a side of the second sub-coupling wiring portion 1h with respect to the semi-finished product 1X of the wiring main body 1A. The main coupling wiring portion 1f is arranged on a side of the second main branch wiring portion 1b in the wiring main body 1B while the main coupling wiring portion 1f is arranged substantially at the center between the side of the first main branch wiring portion 1a and the side of the second main branch wiring portion 1b in the wiring main body 1A (FIG. 5). That is, the wiring main body 1B is used when it is necessary to offset the connector 50 to the side of the second main branch wiring portion 1b.

The wiring main body 1C is formed of a semi-finished product (not illustrated) in which a side of the second main branch wiring portion 1b and a side of the second sub-coupling wiring portion 1h are extended compared to a side of the first main branch wiring portion 1a and a side of the first sub-coupling wiring portion 1g with respect to the semi-finished product 1X of the wiring main body 1A. The main coupling wiring portion 1f is arranged on a side of the first main branch wiring portion 1a in the wiring main body 1C while the main coupling wiring portion 1f is arranged substantially at the center between the side of the first main branch wiring portion 1a and the side of the second main branch wiring portion 1b in the wiring main body 1A (FIG. 6). That is, the wiring main body 1C is used when it is necessary to offset the connector 50 to the side of the first main branch wiring portion 1a.

Similarly to the wiring main body 1A, in each of the wiring main bodies 1B and 1C, a portion between the first main branch wiring portion 1a and the first sub-coupling wiring portion 1g is bent at the first main branch bending portion 1d, a portion between the second main branch wiring portion 1b and the second sub-coupling wiring portion 1h is bent at the second main branch bending portion 1e, a portion between the main coupling wiring portion 1f and the first sub-coupling wiring portion 1g is bent at the first sub-branch bending portion 1i, and a portion between the main coupling wiring portion 1f and the second sub-coupling wiring portion 1h is bent at the second sub-branch bending portion 1j. Thus, similarly to the wiring main body 1A, in each of the wiring main bodies 1B and 1C, a semi-finished product that does not leave a space portion surrounded by the first main branch wiring portion 1a, the second main branch wiring portion 1b, and the coupling wiring portion 1c in the base material can be cut out from the base material regardless of a size of the interval between the first electrode terminal group BC5 and the second electrode terminal group BC6. Thus, in the flexible wiring component 1 of the present embodiment, it is possible to improve a yield of when a plurality of the wiring main bodies 1B or the wiring main bodies 1C is die-cut from the base material regardless of the size of the interval between the first electrode terminal group BC5 and the second electrode terminal group BC6.

In each of the wiring main bodies 1A, 1B, and 1C described above, another component can be arranged in the space portion surrounded by the first main branch wiring portion 1a, the second main branch wiring portion 1b, and the coupling wiring portion 1c. In addition, in each of the wiring main bodies 1A, 1B, and 1C, the first main branch wiring portion 1a, the second main branch wiring portion 1b, and the coupling wiring portion 1c can be arranged in such a manner as to avoid the exhaust duct BD between the first electrode terminal group BC5 and the second electrode terminal group BC6. Thus, protection from high-temperature and high-pressure gas exhausted from the exhaust duct BD is possible.

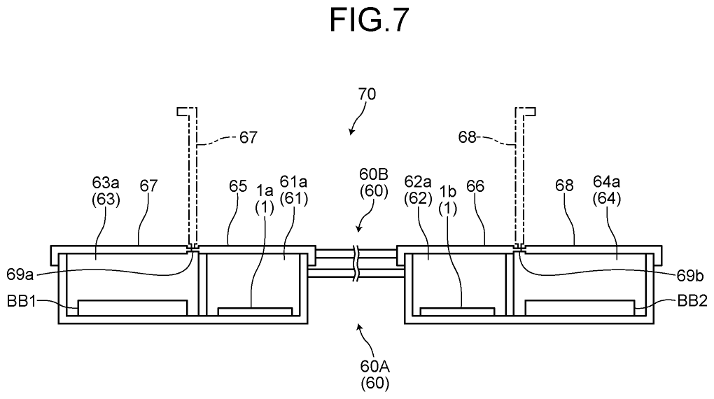

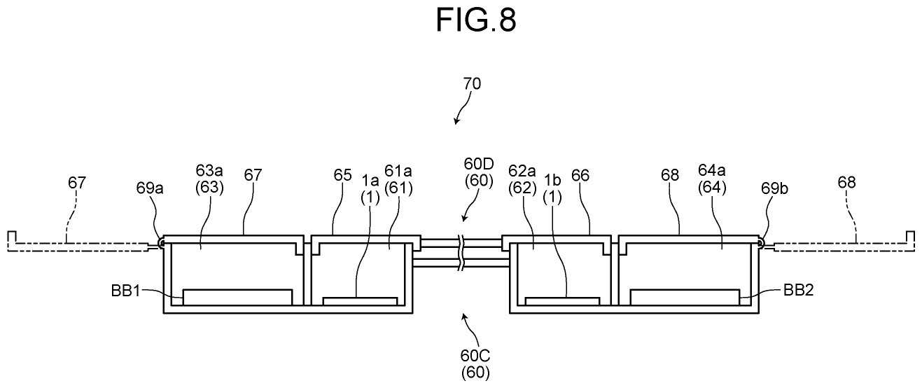

The flexible wiring component 1 of the present embodiment is housed in a case 60 together with the first inter-terminal connection component BB1, the second inter-terminal connection component BB2, the total positive electrode connection component BB3, and the total negative electrode connection component BB4. Here, a component which includes the flexible wiring component 1, the first inter-terminal connection component BB1, the second inter-terminal connection component BB2, the total positive electrode connection component BB3, the total negative electrode connection component BB4, and the case 60, and in which the flexible wiring component 1, the first inter-terminal connection component BB1, the second inter-terminal connection component BB2, the total positive electrode connection component BB3, and the total negative electrode connection component BB4 are housed in the case 60 is referred to as a conductive module 70 (FIG. 7 and FIG. 8). The conductive module 70 can similarly obtain an effect exhibited by the flexible wiring component 1.

In the conductive module 70, the case 60 includes a first housing chamber 61 that houses the first main branch wiring portion 1a from a first opening 61a, a second housing chamber 62 that houses the second main branch wiring portion 1b from a second opening 62a, a third housing chamber 63 that houses the first inter-terminal connection component BB1 and the total positive electrode connection component BB3 from a third opening 63a, a fourth housing chamber 64 that houses the second inter-terminal connection component BB2 and the total negative electrode connection component BB4 from a fourth opening 64a, a first cover portion 65 that closes the first opening 61a, a second cover portion 66 that closes the second opening 62a, a third cover portion 67 that closes the third opening 63a, a fourth cover portion 68 that closes the fourth opening 64a, a first hinge portion 69a that rotates the third cover portion 67 between an open position and a closed position with respect to the third opening 63a, and a second hinge portion 69b that rotates the fourth cover portion 68 between an open position and a closed position with respect to the fourth opening 64a (FIG. 7 and FIG. 8). The case 60 is formed of an insulating material such as synthetic resin.

For example, the case 60 illustrated in FIG. 7 includes a housing member 60A having the first housing chamber 61, the second housing chamber 62, the third housing chamber 63, and the fourth housing chamber 64, and a cover member 60B having the first cover portion 65, the second cover portion 66, the third cover portion 67, and the fourth cover portion 68, and is acquired by assembling of the housing member 60A and the cover member 60B. In the case 60, a first hinge portion 69a and a second hinge portion 69b are provided in the cover member 60B. In the cover member 60B, the first hinge portion 69a is provided between the first cover portion 65 and the third cover portion 67, and the third cover portion 67 is rotated around an axis of the first hinge portion 69a with respect to the first cover portion 65, whereby the third cover portion 67 is rotated between an open position and a closed position with respect to the third opening 63a. In addition, in the cover member 60B, the second hinge portion 69b is provided between the second cover portion 66 and the fourth cover portion 68, and the fourth cover portion 68 is rotated around an axis of the second hinge portion 69b with respect to the second cover portion 66, whereby the fourth cover portion 68 is rotated between an open position and a closed position with respect to the fourth opening 64a. Thus, the case 60 can reduce the number of components. In the case 60, since the third cover portion 67 and the fourth cover portion 68 can be retracted to the open positions, workability of laser welding between the first inter-terminal connection component BB1, the second inter-terminal connection component BB2, or the like and the electrode terminal BC2 (workability in a case of screwing) can be improved.

In addition, the case 60 illustrated in FIG. 8 includes a housing member 60C having the first housing chamber 61, the second housing chamber 62, the third housing chamber 63, the fourth housing chamber 64, the third cover portion 67, and the fourth cover portion 68, and a cover member 60D having the first cover portion 65 and the second cover portion 66, and is acquired by assembling of the housing member 60C and the cover member 60D. In the case 60, the first hinge portion 69a and the second hinge portion 69b are provided in the housing member 60C. In the housing member 60C, the first hinge portion 69a is provided between an outer wall of the third housing chamber 63 and the third cover portion 67, and the third cover portion 67 is rotated around an axis of the first hinge portion 69a with respect to the third housing chamber 63, whereby the third cover portion 67 is rotated between an open position and a closed position with respect to a third opening 63a. Furthermore, in the housing member 60C, the second hinge portion 69b is provided between an outer wall of the fourth housing chamber 64 and the fourth cover portion 68, and the fourth cover portion 68 is rotated around the axis of the second hinge portion 69b with respect to the fourth housing chamber 64, whereby the fourth cover portion 68 is rotated between an open position and a closed position with respect to a fourth opening 64a. Thus, the case 60 can reduce the number of components. In the case 60, since the third cover portion 67 and the fourth cover portion 68 can be retracted to the open positions, workability of laser welding between the first inter-terminal connection component BB1, the second inter-terminal connection component BB2, or the like and the electrode terminal BC2 (workability in a case of screwing) can be improved.

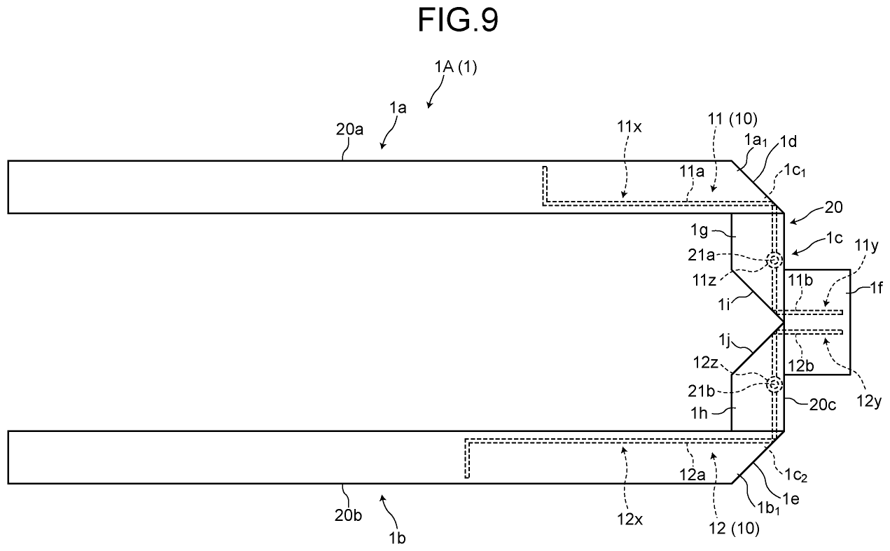

Here, when the flexible wiring component 1 is configured as the double-sided flexible printed circuit board, an area in which the circuit pattern can be formed can be increased compared to a case where the flexible wiring component 1 is configured as the single-sided flexible printed circuit board described above. In a case where the flexible wiring component is configured as the double-sided flexible printed circuit board, a circuit replacement portion (first circuit replacement portion 11z and second circuit replacement portion 12z (described later)) that electrically connects a portion routed on one surface of the base film 21 and a portion routed on the other surface of the base film 21 is provided in each of the first voltage detection line 11 and the second voltage detection line (FIG. 9). The circuit replacement portion is desirably provided in the coupling wiring portion 1c, more specifically, in a flat plate-like portion of the coupling wiring portion 1c excluding the first sub-branch bending portion 1i and the second sub-branch bending portion 1j.

Specifically, the first voltage detection line 11 includes a first terminal-side routing portion 11x that is routed on the one surface of the base film 21 and that is electrically connected to the first inter-terminal connection component BB1 (total positive electrode connection component BB3), a first counterpart routing portion 11y that is routed on the other surface of the base film 21 and electrically connected to the battery monitoring unit UM, and a first circuit replacement portion 11z that electrically connects the first terminal-side routing portion 11x and the first counterpart routing portion 11y via a through hole 21a of the base film 21 in the coupling wiring portion 1c (FIG. 9). The first circuit replacement portion 11z is provided in the middle of the first unit-side connection portion 11b. The first circuit replacement portion 11z is a plated portion formed by electroplating or the like on a peripheral wall of the through hole 21a, and is physically and electrically connected to the first terminal-side routing portion 11x and the first counterpart routing portion 11y.

In addition, the second voltage detection line 12 includes a second terminal-side routing portion 12x that is routed on the one surface of the base film 21 and that is electrically connected to the second inter-terminal connection component BB2 (total negative electrode connection component BB4), a second counterpart routing portion 12y that is routed on the other surface of the base film 21 and that is electrically connected to the battery monitoring unit UM, and a second circuit replacement portion 12z that electrically connects the second terminal-side routing portion 12x and the second counterpart routing portion 12y via a through hole 21b of the base film 21 in the coupling wiring portion 1c (FIG. 9). The second circuit replacement portion 12z is provided in the middle of the second unit-side connection portion 12b. The second circuit replacement portion 12z is a plated portion formed by electroplating or the like on a peripheral wall of the through hole 21b, and is physically and electrically connected to the second terminal-side routing portion 12x and the second counterpart routing portion 12y.

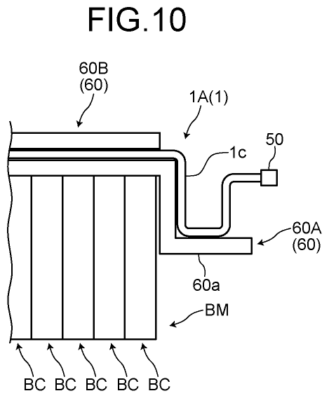

In the flexible wiring component 1, the housing member 60A (60C) of the case 60 is extended from an upper surface to a side surface of the battery module BM, and the coupling wiring portion 1c is fixed to a side surface portion 60a of the housing member 60A (60C) (FIG. 10). For example, the coupling wiring portion 1c may be fixed to the side surface portion 60a with an adhesive or the like, or may be sandwiched and fixed between the side surface portion 60a and a pressing member (not illustrated). As described above, in the flexible wiring component 1, since the first circuit replacement portion 11z and the second circuit replacement portion 12z having low flexibility are provided in the coupling wiring portion 1c (flat plate-like portion of the coupling wiring portion 1c excluding the first sub-branch bending portion 1i and the second sub-branch bending portion 1j) and the coupling wiring portion 1c is fixed to the side surface portion 60a of the housing member 60A (60C), disconnection of the first voltage detection line 11 and the second voltage detection line 12 can be suppressed.

Furthermore, the flexible wiring component 1 may be configured in the following manner and an area where a circuit pattern can be formed may be increased.

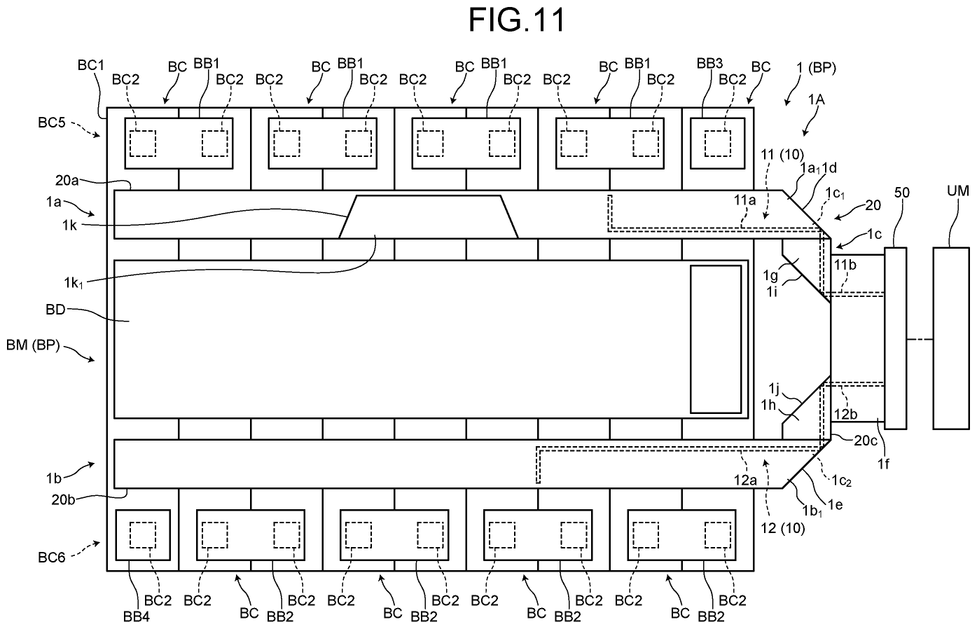

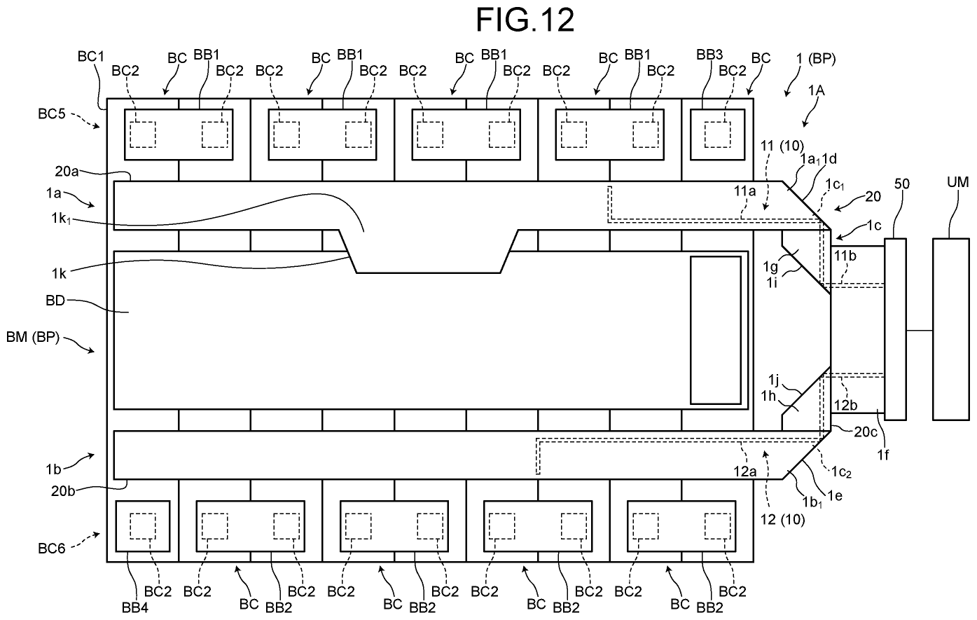

In this case, a main branch wiring portion of a circuit increase target in at least one of the first main branch wiring portion 1a and the second main branch wiring portion 1b has an increase circuit wiring portion 1k that protrudes from an end portion on a side of the space portion surrounded by the first main branch wiring portion 1a, the second main branch wiring portion 1b, and the coupling wiring portion 1c, that is folded back by 180 degrees from a root portion 1k₁ on a side of the end portion, and that is stacked on the main branch wiring portion that is the circuit increase target (FIG. 11 and FIG. 12). The voltage detection line group 10 includes the first voltage detection line 11 or the second voltage detection line 12 in the main branch wiring portion of the circuit increase target which line passes through the increase circuit wiring portion 1k. Here, the increase circuit wiring portion 1k is provided in the first main branch wiring portion 1a, and the first voltage detection line 11 passing through the increase circuit wiring portion 1k is provided in the voltage detection line group 10.

Even in a case where the increase circuit wiring portion 1k is arranged in such a manner as to face the exhaust duct BD when the flexible wiring component 1 is assembled to the battery module BM (FIG. 12), the increase circuit wiring portion 1k is folded back by 180 degrees and stacked on the main branch wiring portion of the circuit increase target (FIG. 11). Thus, the increase circuit wiring portion 1k can be prevented from being directly hit by the high-temperature and high-pressure gas exhausted from the exhaust duct BD. Thus, the flexible wiring component 1 can be protected from the high-temperature and high-pressure gas exhausted from the exhaust duct BD.

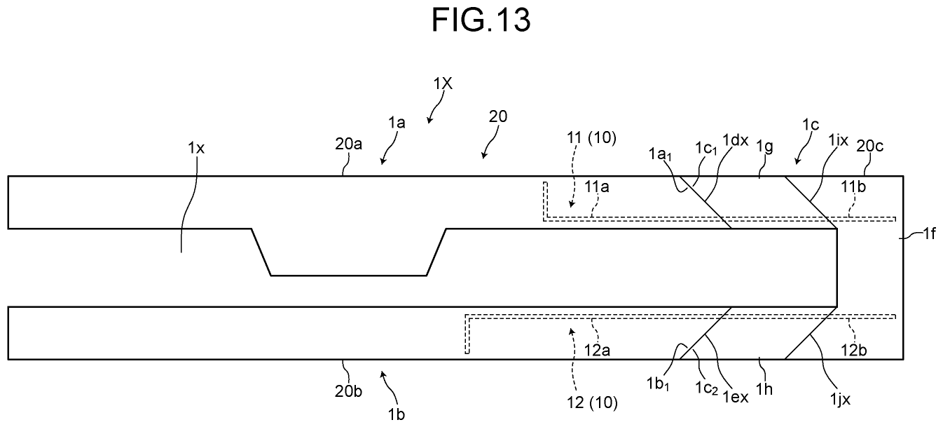

The wiring main body 1A in this case is formed by bending processing of a semi-finished product 1X illustrated in FIG. 13. The semi-finished product 1X has a slit 1x that performs division into the side of the first main branch wiring portion 1a and the side of the first sub-coupling wiring portion 1g, the side of the second main branch wiring portion 1b and the side of the second sub-coupling wiring portion 1h, and the side of the main coupling wiring portion 1f, and that has intervals between the side of the first main branch wiring portion 1a and the side of the first sub-coupling wiring portion 1g, and the side of the second main branch wiring portion 1b and the side of the second sub-coupling wiring portion 1h. The increase circuit wiring portion 1k is provided in the slit 1x. The slit 1x is formed together with the increase circuit wiring portion 1k when the semi-finished product 1X is die-cut from the base material.

Similarly to the above example, in the wiring main body 1A, the first sub-coupling wiring portion 1g protruding from the main coupling wiring portion 1f is bent by 90 degrees in the protruding direction thereof at the first sub-branch bending portion 1i, the first main branch wiring portion 1a is bent by 90 degrees at the first main branch bending portion 1d with respect to the first sub-coupling wiring portion 1g, the second sub-coupling wiring portion 1h protruding from the main coupling wiring portion 1f is bent by 90 degrees in the protruding direction thereof in the direction opposite to the first sub-coupling wiring portion 1g at the second sub-branch bending portion 1j, and the second main branch wiring portion 1b is bent by 90 degrees at the second main branch bending portion 1e with respect to the second sub-coupling wiring portion 1h in the same direction as the first main branch wiring portion 1a. In the wiring main body 1A, the increase circuit wiring portion 1k is further bent with respect to the first main branch wiring portion 1a.

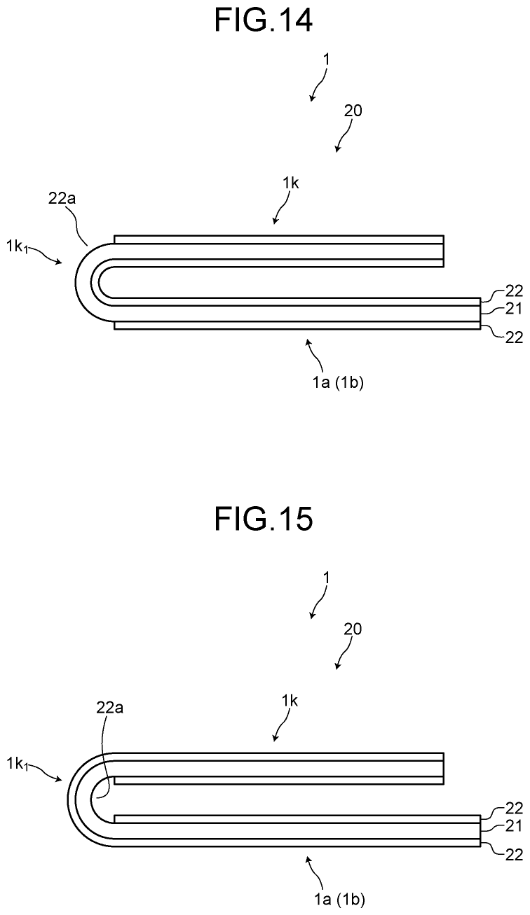

The flexible wiring component 1 is desirably configured in the following manner in order to make it easier to bend the root portion 1k₁ of the increase circuit wiring portion 1k and to leave a bent shape on the root portion 1k₁. Thus, a cut portion 22a in which at least one of a portion on an outer side of bending at the root portion 1k₁ of the increase circuit wiring portion 1k in one coverlay film 22 and a portion on an inner side of the bending at the root portion 1k₁ of the increase circuit wiring portion 1k in the other coverlay film 22 is cut off is provided in the flexible wiring component 1 (FIG. 14 and FIG. 15).

For example, the voltage detection line group 10 (the first voltage detection line 11 and the second voltage detection line 12) is routed at least on a surface on the inner side of the bending at the root portion 1k₁ of the increase circuit wiring portion 1k between the two surfaces of the base film 21. In this case, the cut portion 22a is desirably provided at the portion on the outer side of the bending at the root portion 1k₁ of the increase circuit wiring portion 1k in the one coverlay film 22 in such a manner that the voltage detection line group 10 is not exposed at the root portion 1k₁ of the increase circuit wiring portion 1k (FIG. 14). Thus, in the increase circuit wiring portion 1k, the voltage detection line group 10 (the first voltage detection line 11 and the second voltage detection line 12) is routed on the surface on the inner side of the bending of the base film 21.

In addition, at the root portion 1k₁, by folding back the increase circuit wiring portion 1k, it becomes difficult to make contact with the voltage detection line group 10 (the first voltage detection line 11 and the second voltage detection line 12) inside the bending. Thus, the cut portion 22a may be provided at the portion on the inner side of the bending at the root portion 1k₁ of the increase circuit wiring portion 1k in the other coverlay film 22 (FIG. 15). Furthermore, the cut portion 22a may be provided in each of the portion on the outer side of the bending at the root portion 1k₁ of the increase circuit wiring portion 1k in the one coverlay film 22 and the portion on the inner side of the bending at the root portion 1k₁ of the increase circuit wiring portion 1k in the other coverlay film 22.

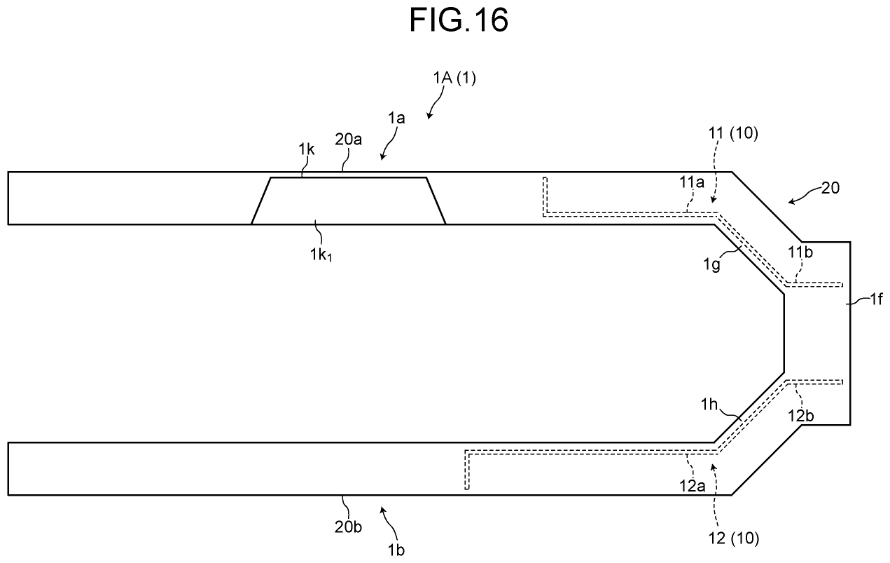

Note that the flexible wiring component 1 having the increase circuit wiring portion 1k may be formed in such a manner that the first main branch bending portion 1d, the second main branch bending portion 1e, the first sub-branch bending portion 1i, and the second sub-branch bending portion 1j do not exist, and bending is performed only at the root portion 1k₁ of the increase circuit wiring portion 1k (FIG. 16).

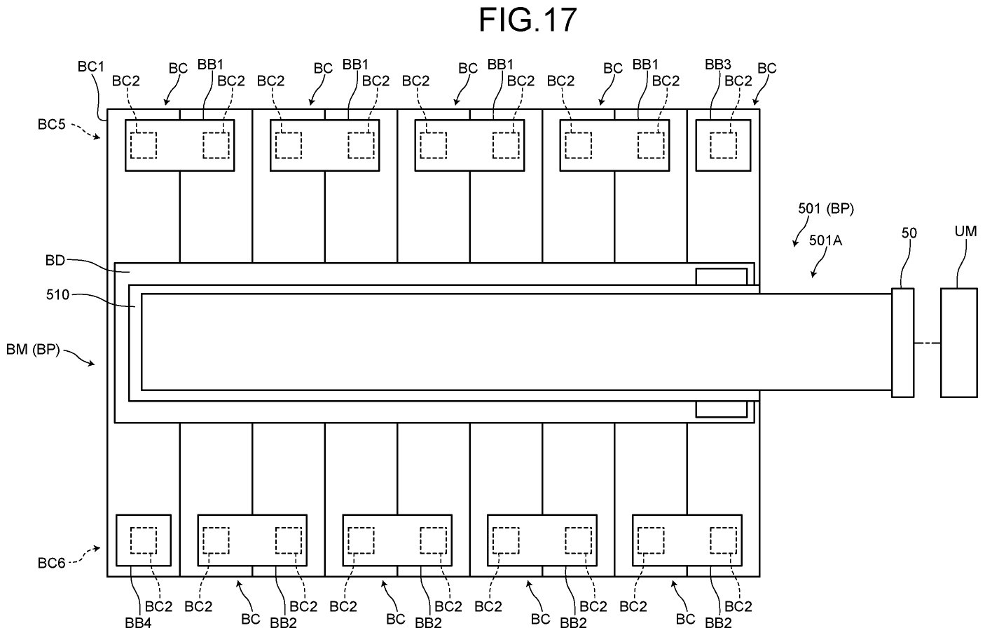

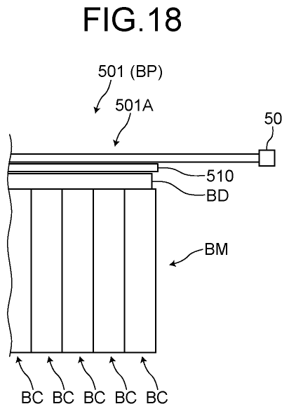

In addition, the flexible wiring component 1 described here branches off from the coupling wiring portion 1c to the first main branch wiring portion 1a and the second main branch wiring portion 1b in order to avoid the exhaust duct BD. However, in a flexible wiring component 501 illustrated in FIG. 17 and FIG. 18, even when a wiring main body 501A is formed in a rectangular flat plate shape, in which such a branch form is not adopted, and the wiring main body 501A is arranged in a facing manner above exhaust duct BD, since a shielding plate 510 is arranged between the wiring main body 501A and the exhaust duct BD, the wiring main body 501A can be prevented from being directly hit by high-temperature and high-pressure gas exhausted from the exhaust duct BD. Thus, the flexible wiring component 501 can be protected from the high-temperature and high-pressure gas exhausted from the exhaust duct BD, and a yield of when a plurality of the wiring main bodies 501A is die-cut from a base material can be improved.

In the flexible wiring component and the conductive module according to the present embodiment, in a wiring main body, a portion between a first main branch wiring portion and a first sub-coupling wiring portion is bent at a first main branch bending portion, a portion between a second main branch wiring portion and a second sub-coupling wiring portion is bent at a second main branch bending portion, a portion between a main coupling wiring portion and the first sub-coupling wiring portion is bent at a first sub-branch bending portion, and a portion between a main coupling wiring portion and a second sub-coupling wiring portion is bent at a second sub-branch bending portion. Thus, in the wiring main body, a semi-finished product in which a space portion surrounded by the first main branch wiring portion, the second main branch wiring portion, and the coupling wiring portion is not left in the base material can be extracted from the base material regardless of a size of the interval between the first electrode terminal group and the second electrode terminal group. Thus, in the flexible wiring component of the present embodiment, regardless of the size of the interval between the first electrode terminal group and the second electrode terminal group, it is possible to improve a yield of when a plurality of the wiring main bodies is die-cut from the base material.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A flexible wiring component comprising:
a wiring main body in which a voltage detection line group that electrically connects a battery module, in which a plurality of battery cells is arrayed in a row, and a battery monitoring unit that monitors a battery state of each of the battery cells is included in insulating coating, the wiring main body being formed flat with flexibility, wherein
in each of the battery cells, positive and negative electrode terminals are provided one by one at intervals on a same plane in a cell body,
the battery module includes a first electrode terminal group in which the electrode terminals on one side in each of the battery cells are arranged in an array direction of the plurality of battery cells and a pair of the electrode terminals on the one side which electrode terminals are adjacent to each other in the array direction is electrically connected by a first inter-terminal connection component for each of the pairs of the electrode terminals on the one side, and a second electrode terminal group in which the electrode terminals on another side of each of the battery cells are arranged in the array direction and a pair of the electrode terminals on the other side which electrode terminals are adjacent to each other in the array direction is electrically connected by a second inter-terminal connection component for each of the pairs of the other electrode terminals,
the voltage detection line group includes a first voltage detection line that is provided for each of the first inter-terminal connection components and that electrically connects the first inter-terminal connection component and the battery monitoring unit, and a second voltage detection line that is provided for each of the second inter-terminal connection components and that electrically connects the second inter-terminal connection component and the battery monitoring unit,
the wiring main body includes a first main branch wiring portion that extends in the array direction on a side of the first electrode terminal group between the first electrode terminal group and the second electrode terminal group, a second main branch wiring portion that extends in the array direction on a side of the second electrode terminal group between the first electrode terminal group and the second electrode terminal group, and a coupling wiring portion that has one end portion continuous with one end portion of the first main branch wiring portion and another end portion continuous with one end portion of the second main branch wiring portion, that couples the one end portions of the first main branch wiring portion and the second main branch wiring portion, and that makes electric connection to the battery monitoring unit,
the first main branch wiring portion is bent at a first main branch bending portion at a boundary between the one end portion thereof and the one end portion of the coupling wiring portion and is extended in the array direction,
the second main branch wiring portion is bent at a second main branch bending portion at a boundary between the one end portion thereof and the other end portion of the coupling wiring portion and is extended in the array direction,
the coupling wiring portion includes a main coupling wiring portion electrically connected to the battery monitoring unit, a first sub-coupling wiring portion that branches off from the main coupling wiring portion, that is coupled to the one end portion of the first main branch wiring portion via the first main branch bending portion, and that electrically connects the main coupling wiring portion and the first main branch wiring portion, and a second sub-coupling wiring portion that branches off from the main coupling wiring portion, that is coupled to the one end portion of the second main branch wiring portion via the second main branch bending portion, and that electrically connects the main coupling wiring portion and the second main branch wiring portion,
the first sub-coupling wiring portion is bent at a first sub-branch bending portion branching off from the main coupling wiring portion and is extended to the one end portion of the first main branch wiring portion, and
the second sub-coupling wiring portion is bent at a second sub-branch bending portion branching off from the main coupling wiring portion and is extended to the one end portion of the second main branch wiring portion.

2. The flexible wiring component according to claim 1, wherein in the wiring main body, the first sub-coupling wiring portion protruding from the main coupling wiring portion is bent by 90 degrees in a protruding direction thereof at the first sub-branch bending portion, the first main branch wiring portion is bent by 90 degrees at the first main branch bending portion with respect to the first sub-coupling wiring portion, the second sub-coupling wiring portion protruding from the main coupling wiring portion is bent by 90 degrees in a protruding direction thereof in a direction opposite to the first sub-coupling wiring portion at the second sub-branch bending portion, and the second main branch wiring portion is bent by 90 degrees at the second main branch bending portion in a same direction as the first main branch wiring portion with respect to the second sub-coupling wiring portion.

3. The flexible wiring component according to claim 1, wherein
the insulating coating includes a base film, and a coverlay film for each surface which coverlay film covers each of surfaces of the base film,
the first voltage detection line includes a first terminal-side routing portion that is routed on one of the surfaces of the base film and electrically connected to the first inter-terminal connection component, a first counterpart routing portion that is routed on another surface of the base film and electrically connected to the battery monitoring unit, and a first circuit replacement portion that electrically connects the first terminal-side routing portion and the first counterpart routing portion via a through hole of the base film in the coupling wiring portion, and
the second voltage detection line includes a second terminal-side routing portion that is routed on the one surface of the base film and electrically connected to the second inter-terminal connection component, a second counterpart routing portion that is routed on the other surface of the base film and electrically connected to the battery monitoring unit, and a second circuit replacement portion that electrically connects the second terminal-side routing portion and the second counterpart routing portion via a through hole of the base film in the coupling wiring portion.

4. The flexible wiring component according to claim 2, wherein
the insulating coating includes a base film, and a coverlay film for each surface which coverlay film covers each of surfaces of the base film,
the first voltage detection line includes a first terminal-side routing portion that is routed on one of the surfaces of the base film and electrically connected to the first inter-terminal connection component, a first counterpart routing portion that is routed on another surface of the base film and electrically connected to the battery monitoring unit, and a first circuit replacement portion that electrically connects the first terminal-side routing portion and the first counterpart routing portion via a through hole of the base film in the coupling wiring portion, and
the second voltage detection line includes a second terminal-side routing portion that is routed on the one surface of the base film and electrically connected to the second inter-terminal connection component, a second counterpart routing portion that is routed on the other surface of the base film and electrically connected to the battery monitoring unit, and a second circuit replacement portion that electrically connects the second terminal-side routing portion and the second counterpart routing portion via a through hole of the base film in the coupling wiring portion.

5. The flexible wiring component according to claim 1, wherein
a main branch wiring portion of a circuit increase target in at least one of the first main branch wiring portion and the second main branch wiring portion has an increase circuit wiring portion that protrudes from an end portion on a side of a space portion surrounded by the first main branch wiring portion, the second main branch wiring portion, and the coupling wiring portion, that is folded back by 180 degrees from a root portion on a side of the end portion, and that is stacked on the main branch wiring portion of the circuit increase target, and
the voltage detection line group includes the first voltage detection line or the second voltage detection line in the main branch wiring portion of the circuit increase target which line passes through the increase circuit wiring portion.

6. The flexible wiring component according to claim 2, wherein
a main branch wiring portion of a circuit increase target in at least one of the first main branch wiring portion and the second main branch wiring portion has an increase circuit wiring portion that protrudes from an end portion on a side of a space portion surrounded by the first main branch wiring portion, the second main branch wiring portion, and the coupling wiring portion, that is folded back by 180 degrees from a root portion on a side of the end portion, and that is stacked on the main branch wiring portion of the circuit increase target, and
the voltage detection line group includes the first voltage detection line or the second voltage detection line in the main branch wiring portion of the circuit increase target which line passes through the increase circuit wiring portion.

7. A conductive module comprising:
a flexible wiring component;
a first inter-terminal connection component;
a second inter-terminal connection component; and
a case that houses the flexible wiring component, the first inter-terminal connection component, and the second inter-terminal connection component from an opening, wherein
the flexible wiring component includes a wiring main body in which a voltage detection line group that electrically connects a battery module, in which a plurality of battery cells is arrayed in a row, and a battery monitoring unit that monitors a battery state of each of the battery cells is included in insulating coating, the wiring main body being formed flat with flexibility,
in each of the battery cells, positive and negative electrode terminals are provided one by one at intervals on a same plane in a cell body,
the battery module includes a first electrode terminal group in which the electrode terminals on one side of each of the battery cells are arranged in an array direction of the plurality of battery cells and a pair of the electrode terminals on the one side which electrode terminals are adjacent to each other in the array direction is electrically connected by the first inter-terminal connection component for each pair of the electrode terminals on the one side, and a second electrode terminal group in which the electrode terminals on another side of each of the battery cells are arranged in the array direction and a pair of the electrode terminals on the other side which electrode terminals are adjacent to each other in the array direction is electrically connected by the second inter-terminal connection component for each pair of the electrode terminals on the other side,
the voltage detection line group includes a first voltage detection line that is provided for each of the first inter-terminal connection components and that electrically connects the first inter-terminal connection component and the battery monitoring unit, and a second voltage detection line that is provided for each of the second inter-terminal connection components and that electrically connects the second inter-terminal connection component and the battery monitoring unit,
the wiring main body includes a first main branch wiring portion that is extended in the array direction on a side of the first electrode terminal group between the first electrode terminal group and the second electrode terminal group, a second main branch wiring portion that is extended in the array direction on a side of the second electrode terminal group between the first electrode terminal group and the second electrode terminal group, and a coupling wiring portion that has one end portion continuous with one end portion of the first main branch wiring portion and another end portion continuous with one end portion of the second main branch wiring portion, that couples the one end portions of the first main branch wiring portion and the second main branch wiring portion, and makes electrical connection to the battery monitoring unit,
the first main branch wiring portion is bent at a first main branch bending portion at a boundary between the one end portion thereof and the one end portion of the coupling wiring portion and is extended in the array direction,
the second main branch wiring portion is bent at a second main branch bending portion at a boundary between the one end portion thereof and the other end portion of the coupling wiring portion and is extended in the array direction,
the coupling wiring portion includes a main coupling wiring portion electrically connected to the battery monitoring unit, a first sub-coupling wiring portion that branches off from the main coupling wiring portion, that is coupled to the one end portion of the first main branch wiring portion via the first main branch bending portion, and that electrically connects the main coupling wiring portion and the first main branch wiring portion, and a second sub-coupling wiring portion that branches off from the main coupling wiring portion, that is coupled to the one end portion of the second main branch wiring portion via the second main branch bending portion, and that electrically connects the main coupling wiring portion and the second main branch wiring portion,
the first sub-coupling wiring portion is bent at a first sub-branch bending portion branching off from the main coupling wiring portion and is extended to the one end portion of the first main branch wiring portion,
the second sub-coupling wiring portion is bent at a second sub-branch bending portion branching off from the main coupling wiring portion and is extended to the one end portion of the second main branch wiring portion, and
the case includes a first housing chamber that houses the first main branch wiring portion from a first opening, a second housing chamber that houses the second main branch wiring portion from a second opening, a third housing chamber that houses the first inter-terminal connection component from a third opening, a fourth housing chamber that houses the second inter-terminal connection component from a fourth opening, a first cover portion that closes the first opening, a second cover portion that closes the second opening, a third cover portion that closes the third opening, a fourth cover portion that closes the fourth opening, a first hinge portion that rotates the third cover portion between an open position and a closed position with respect to the third opening, and a second hinge portion that rotates the fourth cover portion between an open position and a closed position with respect to the fourth opening.
